(19) United States
(12) Patent Application Publication
(10) Pub. No.: US 2016/0175809 A1
(43) Pub. Date: Jun. 23, 2016

(54) RECYCLABLE AND REUSABLE OXYGEN SCAVENGER

(71) Applicant: EMPIRE TECHNOLOGY DEVELOPMENT LLC, Wilmington, DE (US)

(72) Inventor: Arockiadoss THEVASAHAYAM, Madurai, Tamilnadu (IN)

(21) Appl. No.: 14/409,978

(22) PCT Filed: May 30, 2013
(86) PCT No.: PCT/IB13/54465

§ 371 Date: Dec. 19, 2014

(30) Foreign Application Priority Data
Jun. 19, 2012 (IN) 2430/CHE/2012

(51) Int. Cl. B01J 20/22; B32B 27/30; B32B 27/32; B32B 27/06; B65D 81/26; B32B 27/36

(52) U.S. Cl. CPC B01J 20/223; B65D 81/266; B32B 27/36; B32B 27/32; B32B 27/06; B32B 27/302; B32B 2250/02; B32B 2439/70

(57) ABSTRACT

Disclosed herein are reusable composite materials for scavenging oxygen, methods of preparing the composite materials and method of using them. The composite materials contain porphyrin molecules and a metal oxide comprised within the porphyrin. The metal oxide is oxidizable in the presence of oxygen and the oxidation of the metal oxide is reversible upon exposure of the composite material to light of a fixed wavelength.

### CROSS-REFERENCE TO RELATED APPLICATIONS

This application is a PCT application that claims the benefit of Indian Application No. 2430/CHE/2012, filed on Jun. 19, 2012, the entire contents of which are incorporated herein by reference in its entirety.

### BACKGROUND OF DISCLOSURE

Food decay is a major economic problem in the food packaging and distribution industry. Contact with oxygen causes degradation of the food stuff and fresh produce due to unwanted oxidative reactions that result in off-flavors, odors and sometimes formation of harmful compounds. Oxygen, in the presence of moisture, promotes the growth of microbes and mold in meat products, and also contributes to lipid degradation resulting in oxidized or rancid odor. Hence, oxygen management is of particular importance in the meat-packing industry. Therefore, protection of packaged foods from oxygen would be desirable to increase shelf life and/or reduce the cost burden on the customer.

There have been many approaches, both passive and active, to scavenge oxygen from packaged food products. Typical oxygen scavengers include mixtures of iron oxide powder and salt, wherein the iron powder absorbs oxygen to form rust. Oxygen scavengers exist in many forms, including sachets, films and enzymes, which can each be used in food systems and function in a variety of ways. In addition to sachets, oxygen-scavenging compounds can also be incorporated directly into the packaging material itself. These materials include flexible films, rigid plastics (blow-molded or injection-molded polymers) and liners in closures. To be effective, the scavengers need to be able to absorb large quantities of oxygen, be economically priced and, importantly, contain no toxic products that will come in contact with the consumer. However, the present oxygen scavengers used in the food industry are not recyclable and reusable. Accordingly, there remains a need for improved oxygen scavenging materials that are reusable, recyclable, non-toxic, and affordable.

### SUMMARY OF DISCLOSURE

The present disclosure is directed towards recyclable and reusable oxygen scavenging materials that can be produced at a very low cost. In one embodiment, a reusable composite material for scavenging oxygen may include at least one porphyrin molecule and at least one metal oxide within the porphyrin, wherein the at least one metal oxide is oxidizable in the presence of oxygen and the oxidation of the at least one metal oxide is reversible upon exposure of the composite material to light of a fixed wavelength.

In an additional embodiment, a method for preparing a composite material for scavenging oxygen includes mixing at least one metal oxide with a solution of thiol to form a metal oxide-thiol complex, mixing the metal oxide-thiol complex with a solution of cross-linking agent to form a first reaction mixture, and mixing the first reaction mixture with a solution of at least one porphyrin to form a porphyrin-metal oxide composite material.

In another embodiment, an article for scavenging oxygen may include at least one supporting material and at least one reusable composite material. The composite material may include at least one porphyrin molecule and at least one metal oxide within the porphyrin, wherein the at least one metal oxide is oxidizable in the presence of oxygen and the oxidation of the at least one metal oxide is reversible upon exposure of the composite material to light of a fixed wavelength. Further, the reusable composite material may be in contact with at least one surface of the supporting material.

In a further embodiment, a method of making an article for scavenging oxygen includes providing at least one reusable composite material for scavenging oxygen, contacting the composite material with a solution of polymeric material to form a polymer mixture, and applying the polymer mixture to the article. The composite material may include at least one porphyrin molecule and at least one metal oxide within the porphyrin. The at least one metal oxide may be oxidizable in the presence of oxygen and the oxidation of the at least one metal oxide can be reversible upon exposure of the composite material to light of a fixed wavelength.

In an additional embodiment, a method for scavenging oxygen from a mixture of gases includes providing at least one reusable composite material, and contacting the composite material with a mixture of gases from which oxygen is to be removed, whereby the oxygen is selectively scavenged from the mixture of gases by the composite material. The composite material may include at least one porphyrin molecule and at least one metal oxide within the porphyrin, wherein the at least one metal oxide is oxidizable in the presence of oxygen and the oxidation of the at least one metal oxide is reversible upon exposure of the composite material to light of a fixed wavelength.

### BRIEF DESCRIPTION OF THE ACCOMPANYING DRAWINGS

FIGS. 1A and 1B demonstrate the X-ray diffraction of protoporphyrin IX-Fe₃O₄ and protoporphyrin IX-Fe₂O₃, respectively, before and after exposure to a light of 630 nm.

FIG. 2 illustrates manufacturing of a polypropylene film having protoporphyrin IX-Fe₂O₃ particles on the surface.

FIGS. 3A and 3B show amounts of oxygen adsorbed and released in samples having different amounts of protoporphyrin IX-Fe₂O₃ particles coated on a glass plate, and for different sizes of coated areas on the glass plate. In both Figures, the square symbols represent a 1.0 cm² area of coating, the round symbols represent a 1.5 cm² area of coating, and the triangle symbols represent a 2.0 cm² area of coating.

### DETAILED DESCRIPTION OF DISCLOSURE

This disclosure is not limited to the particular systems, devices and methods described, as these may vary. The terminology used in the description is for the purpose of describing the particular versions or embodiments only, and is not intended to limit the scope.

Many oxygen scavenging materials are currently being utilized in food stuffs such as beer, fresh pastas, coffee, cured meats, beverages, baked goods, produce and others. Oxygen scavengers provide many benefits such as increasing the product shelf life, preventing the growth of aerobic pathogens, reducing the oxidation of vitamins (Vitamin A, C, and E), and preventing the growth and hatching of insect eggs. Use of oxygen scavengers may also provide the benefits of maintaining the color, flavor and overall freshness of products, and extending markets for global distribution due to prolonged shelf life of the product. Cost savings are also realized through reduced waste caused by expired shelf life and by having to replace the dated stock less frequently. In addition, oxygen scavengers are also used in pharmaceutical industry to preserve the medicines and vitamins.

The present disclosure provides reusable composite materials to scavenge oxygen, methods to make composite materials and methods to scavenge oxygen. In one embodiment, the composite material may include at least one porphyrin molecule and at least one metal oxide within the porphyrin, wherein the at least one metal oxide is oxidizable in the presence of oxygen and the oxidation of the at least one metal oxide is reversible upon exposure of the composite material to light of a fixed wavelength.

Oxygen readily forms chemical bonds with alkali and transition metals without further need for additional chemical processes. For example, iron (Fe) can convert to iron oxides with multiple oxidation states, such as FeO, Fe₂O₃ and Fe₃O₄, upon exposure to oxygen. In some embodiments, the metal oxide in the composite material may be a transition metal oxide. Examples of transition metal oxides include, but are not limited to, vanadium (II) oxide, iron (III) oxide, manganese (III) oxide, chromium (II) oxide, cobalt (II) oxide, nickel (II) oxide, copper (I) oxide, and combinations thereof.

The metal oxide is covalently attached to the porphyrin ring and in some embodiments may be present in the center of four pyrrole subunits. Some examples for porphyrin molecules include protoporphyrin IX, porphine, octaethylporphine, hematoporphyrin IX, etioporphyrin, etioporphyrin I, meso-tetraphenylporphine, coproporphyrin I, coproporphyrin III, deuteroporphyrin IX, mesoporphyrin IX, tetratosylate, uroporphyrin I, iso-hematoporphyrin IX, and combinations thereof.

In some embodiments, the composite material may be in the form of microspheres. In some embodiments, the average diameter of the microspheres may be from about 100 nm to about 500 nm, from about 100 nm to about 400 nm, from about 100 nm to about 300 nm, or from about 200 nm to about 500 nm. Specific examples include about 100 nm, about 200 nm, about 300 nm, about 400 nm, about 500 nm, and ranges between any two of these values.

The present disclosure provides composite materials where the oxidation of the metal oxide is reversible, thereby rendering the composite material for reuse. This may be achieved by exposing the composite material to light of a fixed wavelength, thus reversing the oxidation of the metal oxide and releasing the scavenged oxygen. For example, photoactivation of porphyrin releases an electron which cleaves the Fe—O bond in Fe₃O₄, thereby releasing oxygen and reverting back to Fe₂O₃ state. A range of optical wavelengths can be used to photoactivate porphyrins. In some embodiments, the wavelength of the optical light may be from about 380 nm to about 750 nm, from about 400 nm to about 750 nm, from about 500 nm to about 750 nm, from about 600 nm to about 750 nm, or from about 380 nm to about 600 nm. Specific examples include about 380 nm, about 400 nm, about 500 nm, about 600 nm, about 750 nm, and ranges between any two of these values. The time period required for the exposure to light may be from about 1 minute to about 60 minutes, from about 1 minute to about 45 minutes, from about 1 minute to about 30 minutes, or from about 1 minute to about 15 minutes. Specific examples include about 1 minute, about 10 minutes, about 20 minutes, about 30 minutes, about 40 minutes, about 50 minutes, about 60 minutes, and ranges between any two of these values. Further, the time periods can vary depending on the intensity of the light.

In some embodiments, the composite material may be incorporated into an article. The article may be, for example, a container, a bag, a film, a packaging material or a sachet. In some embodiments, the article may contain a supporting material for holding the oxygen scavenging composite material. Further, the composite material is in contact with at least one surface of the supporting material. In some embodiments, the supporting material may be a polymer, such as polyethylene terephthalate, high-density polyethylene, low-density polyethylene, polypropylene, polystyrene, collagen, or a combination thereof. In some embodiments, the supporting material may be a sachet formed from a fibrous material, a synthetic material, a ceramic material, or a combination thereof. In some embodiments, the composite material may be present on the interior surface of a package (e.g., a rigid container such as a can, can lid, box, carton, or the like). In some embodiments, the article may be a carrier film which carries the present composite material. The carrier film may be formed from a polymeric material, such as those described herein, capable of forming a film with the composite material deposited on a surface of the film. The film may be composed of a single layer or of a plurality of layers.

In some embodiments, the surface of the polymeric film may be coated with the oxygen scavenging composite material by forming a suspension or dispersion of the particulate in a polymer and depositing the suspension or dispersion by a conventional means, such as spraying or knife coating application or the like, directly onto the film surface. In some embodiments, the composite material is mixed with the solution of polymeric material dissolved in acetone to form a polymer mixture. Mixing may be performed for about 10 minutes to about 60 minutes, for about 10 minutes to about 45 minutes, for about 10 minutes to about 30 minutes, or for about 10 minutes to about 15 minutes. Specific time points include about 10 minutes, about 15 minutes, about 30 minutes, about 45 minutes, about 60 minutes, and ranges between any two of these values. In some embodiments, the polymer mixture may be molded into a flat film using magnetic chill rollers. In other embodiments, the polymeric mixture may be applied to an article by coating, spraying, brushing, fusing, or a combination thereof.

In some embodiments, the composite material can change its color after scavenging oxygen. An exemplary composite material is a protoporphyrin IX containing Fe₂O₃ particles. Fe₂O₃ (brown) converts to Fe₃O₄ (black) on exposure to oxygen. In some embodiments, the composite material may be coated on the interior surface of an enclosure used for food preservation. The coated surface modifies the atmosphere within the airtight enclosure by removing the oxygen. The composite material may be recovered by exposing the coated surface to optical illumination of about 630 nm to regenerate the surface to be reused for oxygen scavenging.

In some embodiments, the composite material may be used as an oxygen sensor. The composite material may be incorporated into a film or a paper and exposed to oxygen environment, for example a food package. The change in color of Fe₂O₃ from brown to black after scavenging oxygen can indicate the presence of oxygen in the food package.

In some embodiments, the composite material may be used as solid-state oxygen carrier or concentrator. After scavenging oxygen, the composite material may be easily collected by magnet from various environments. In some embodiments, the composite material may be used as an oxygen scrubber for removing oxygen from a mixture of gases. Examples of such situation may be scavenging oxygen from natural gas pipelines, electrochemical processes and chemical processes that require oxygen-free atmosphere, and for anaerobic processes. In some embodiments, the composite material can be incorporated in an article, for example a polymeric film. Further, the composite material may be reused by removing the scavenged oxygen. This may be performed by exposing composite material to light having a wavelength of about 380 nm to about 750 nm. Further, the composite material may be recovered by heating the polymeric film to form a liquid and separating the composite material from the polymer by filtration, centrifugation, and/or the like. In some cases, protoporphyrin IX-Fe₂O₃ microspheres can be separated by exposing the polymeric liquid to a magnetic field.

In some embodiments, preparing a composite material to scavenge oxygen involves: combining a metal oxide with a thiol to form a metal oxide-thiol complex; mixing the metal oxide-thiol complex with a cross-linking agent to form a first reaction mixture; and mixing the first reaction mixture with a solution of porphyrin to form a porphyrin-metal oxide composite material. In some embodiments, the metal oxide may be any one of the transition metal oxides described herein. The metal oxide is initially treated with a thiol reagent for the purpose of adding functional groups that are required for the cross-linking step. The metal oxide and the thiol can be mixed in a weight to volume ratio of about 1 to about 3. The mixing may be performed for about 15 minutes to about 2 hours, for about 15 minutes to about 1 hour, for about 30 minutes to about 2 hours, or for about 30 minutes to about 1 hour. Specific examples include about 15 minutes, about 30 minutes, about 45 minutes, about 60 minutes, about 120 minutes, and ranges between any two of these values. Examples of thiols that may be used in this reaction include thioctic acid, thiourea, 2-mercaptoethyl amine or 3-mercaptopropionic acid. The mixing may be performed by using an overhead magnetic stirrer, a shaker or by other mixing methods or instruments.

In some embodiments, the metal oxide-thiol complex is further mixed with a solution of cross-linking agent to activate the functional groups present on the metal oxides. The cross-linking agent solution may contain equimolar amounts of ethylenediamine carbodiimide, N-hydroxysuccinimide, and 2-(N-morpholino) ethanesulfonic acid. The mixing is performed for about 10 minutes by using an overhead magnetic stirrer, a shaker or by other means. The pH of the cross-linking agent solution may be about 5 to about 8, about 5 to about 7, or about 5 to about 6. Specific values include a pH of about 5, a pH of about 6, a pH of about 7, a pH of about 7.5, a pH of about 8, and ranges between any two of these values.

In some embodiments, a metal oxide with activated functional groups is mixed with a porphyrin solution. The porphyrin may be any of the porphyrin molecules described herein. In some embodiments, the porphyrin is dispersed in methanol in about 0.04 to about 0.09 weight to volume percent, about 0.04 to about 0.08 weight to volume percent, about 0.04 to about 0.066 weight to volume percent, or about 0.04 to about 0.06 weight to volume percent. Specific values include about 0.04 weight to volume percent, about 0.06 weight to volume percent, about 0.066 weight to volume percent, about 0.07 weight to volume percent, about 0.08 weight to volume percent, about 0.09 weight to volume percent, and ranges between any two of these values. The mixing of the metal oxide solution with the porphyrin solution may be performed for about 2 hours. The resulting porphyrin-metal oxide composite material may be removed from the unreacted components using a magnetic field.

### EXAMPLES

### Example 1

### Preparation of Protoporphyrin IX-Fe₂O₃ Microspheres

About 10 milligrams of ferric oxide having particles with an average size of about 100 nanometers to about 500 nanometers was dispersed in 30 ml of 3-mercaptopropionic acid in the ratio of 1:3 wt/vol and mixed using an overhead stirrer for about 30 minutes. A solution containing 50 mM of ethylenediamine carbodiimide, 50 mM of N-hydroxysuccinimide (NHS) and 50 mM of 2-(N-morpholino) ethanesulfonic (MES) acid was added to the above ferric oxide solution, and the mixing was continued for about 10 minutes. About 2 milligrams of protoporphyrin IX dissolved in 3 ml of methanol was added to the above mixture and the mixing was continued for another 2 hours. The resulting protoporphyrin IX-Fe₂O₃ particles were separated using a magnetic field of about 0.1 Tesla and washed with water.

### Example 2

### Preparation of Protoporphyrin IX-Copper Oxide

About 10 milligrams of copper oxide is dispersed in 30 ml of 3-mercaptopropionic acid in the ratio of 1:3 wt/vol and mixed using an overhead stirrer for about 30 minutes. A solution containing 50 mM of ethylenediamine carbodiimide, 50 mM of N-hydroxysuccinimide (NHS) and 50 mM of 2-(N-morpholino) ethanesulfonic (MES) acid is added to the above copper oxide solution, and the mixing is continued for about 10 minutes. About 2 milligrams of protoporphyrin IX dissolved in 3 ml of methanol is added to the above mixture and the mixing is continued for another 2 hours. The resulting protoporphyrin IX-copper oxide particles are separated by filtration and washed with water.

### Example 3

### Preparation of Polypropylene Film Having Protoporphyrin IX-Fe₂O₃ Particles on its Surface

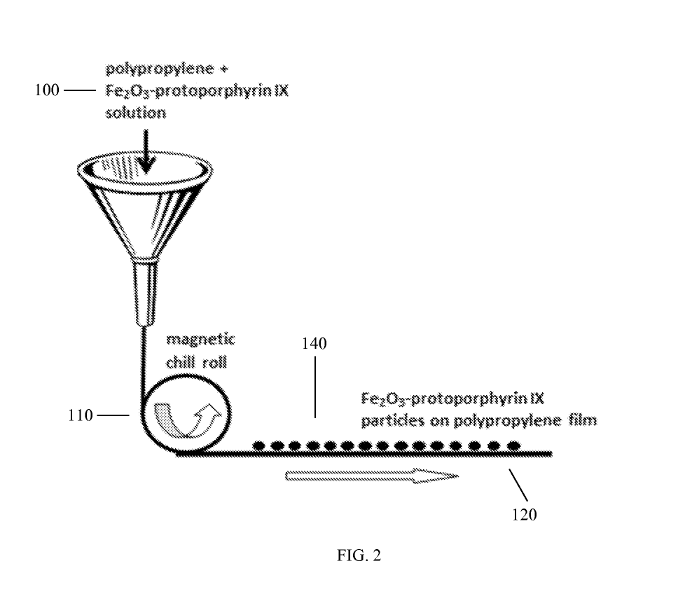

A polymer solution was formed by dissolving about 3 grams of polypropylene in 50 ml of acetone. About 3 milligrams of the protoporphyrin IX-Fe₂O₃ particles from Example 1 was added to the polymer solution and stirred for about 15 minutes at 1500 RPM to form a molding mixture. The molding mixture was molded into a film using a magnetic chill roller 110 as shown in FIG. 2. Referring to FIG. 2, the molding mixture 100 was fed into the magnetic chill roller 110, which formed the molding mixture 100 into a flat film 120 having the protoporphyrin IX-Fe₂O₃ particles 140 on a surface of the film 120.

### Example 4

### Partial Pressure Measurements

An experiment was performed to measure the rate of oxygen adsorption by the protoporphyrin IX-Fe₂O₃ particles. A polypropylene film having about 30 milligrams of protoporphyrin IX-Fe₂O₃ particles on its surface was placed in a sealed container attached to a simple manometer. The change in the pressure due to oxygen adsorption was measured at different time intervals (Table 1). The change in pressure is expressed as millimeters (mm) of displaced water.

TABLE 1

| Time period | Pressure |
|---|---|
| (minutes) | (in mm of water) |
| 5 | 18 |
| 10 | 21 |
| 15 | 27 |
| 20 | 28 |
| 25 | 28 |
| 30 | 28 |

Table 2 shows data from an another experiment performed with differing amounts of protoporphyrin IX-Fe₂O₃ particles used for adsorbing oxygen. The protoporphyrin IX-Fe₂O₃ particles were exposed to oxygen for 15 minutes. As expected, increasing amounts of protoporphyrin IX-Fe₂O₃ particles led to increasing changes in the pressure inside the sealed container. The change in pressure is expressed as millimeters (mm) of displaced water. These experiments demonstrate that the protoporphyrin IX-Fe₂O₃ particles can efficiently adsorb oxygen.

TABLE 2

| Protoporphyrin IX- | Pressure |
|---|---|
| Fe₂O₃ particles | (in mm of water) |
| 10 mg | 5 |
| 20 mg | 15 |
| 30 mg | 27 |
| 40 mg | 41 |
| 50 mg | 56 |

### Example 5

### Regeneration of Protoporphyrin IX-Fe₂O₃ Particles

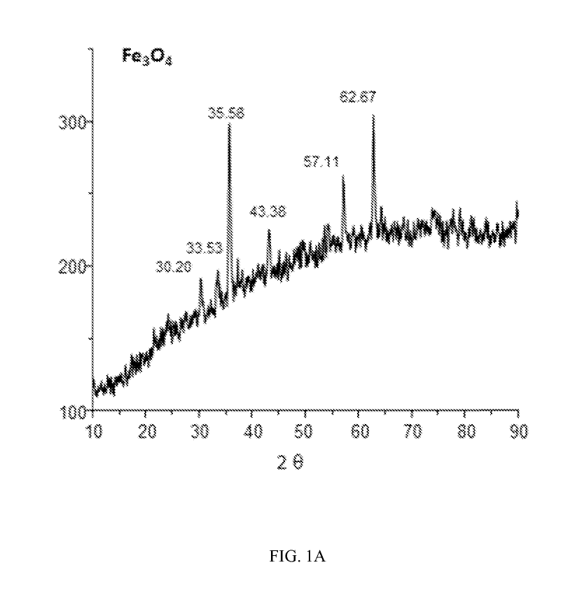

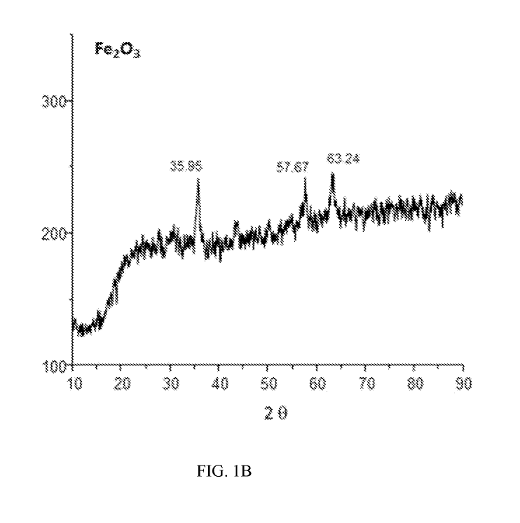

A sample of 30 milligrams of protoporphyrin IX-Fe₃O₄ particles was exposed to red light (630 nanometers, 500 lumens) for about 10 minutes. An X-ray diffraction (XRD) of the protoporphyrin IX-Fe₃O₄ particles before exposure to the red light is shown in FIG. 1A, and after exposure to the red light is shown in FIG. 1B. The XRD in FIG. 1A and in FIG. 1B indicate that the exposure to the red light regenerates protoporphyrin IX-Fe₂O₃ particles from protoporphyrin IX-Fe₃O₄ particles. A color change of the particles from black to brown was also observed, due to the conversion of protoporphyrin IX-Fe₃O₄ (black) to protoporphyrin IX-Fe₂O₃ (brown).

### Example 6

### Oxygen Adsorption and Oxygen Release Measurements

An experiment was performed to measure the amount of oxygen adsorbed and released by the protoporphyrin IX-Fe₂O₃ particles. A glass plate having an amount of the protoporphyrin IX-Fe₂O₃ particles coated on its surface was placed in a sealed container attached to an oxygen sensor. The container was placed in an environment with no ambient light. The oxygen sensor measures the oxygen level as a percentage of oxygen, by volume, present in the air within the container. An initial oxygen level in the sealed container was measured at the start of the experiment. The container had a volume of 65 cm³, and was maintained at a relative humidity of 56% at a temperature of 32° C. The oxygen level within the container was measured again 30 minutes later. A change in the oxygen level at the start of the experiment and at 30 minutes was recorded. This change indicates the amount of oxygen adsorbed by the protoporphyrin IX-Fe₂O₃ particles, expressed as a change in percentage of oxygen, by volume, present in the air within the sealed container.

The protoporphyrin IX-Fe₂O₃ particles on the glass plate, upon adsorption of oxygen, oxidized to form protoporphyrin IX-Fe₃O₄ particles. The glass plate with the oxidized particles was exposed to red light (630 nanometers, 500 lumens) for 30 minutes. When exposed to the red light, the adsorbed oxygen was released into the sealed container. The oxygen level in the sealed container was measured just before the exposure to red light, and at 30 minutes after the exposure. A change in the oxygen level at 30 minutes after the exposure to red light and at a time just before the exposure was recorded. This change indicates the amount of oxygen released by the oxidized particles, expressed as a change in percentage of oxygen, by volume, present in the air within the sealed container.

The experiment was repeated for a range of glass plates having different quantities of protoporphyrin IX-Fe₂O₃ particles coated on its surface, and having different sizes of coated areas, as listed in Table 3 below.

TABLE 3

| Protoporphyrin IX- | Area of Coating |
|---|---|
| Fe₂O₃ particles | (cm²) |
| 10 mg | 1 |
| 20 mg | 1 |
| 30 mg | 1 |
| 40 mg | 1 |
| 50 mg | 1 |
| 10 mg | 1.5 |
| 20 mg | 1.5 |
| 30 mg | 1.5 |
| 40 mg | 1.5 |
| 50 mg | 1.5 |
| 10 mg | 2 |
| 20 mg | 2 |
| 30 mg | 2 |
| 40 mg | 2 |
| 50 mg | 2 |

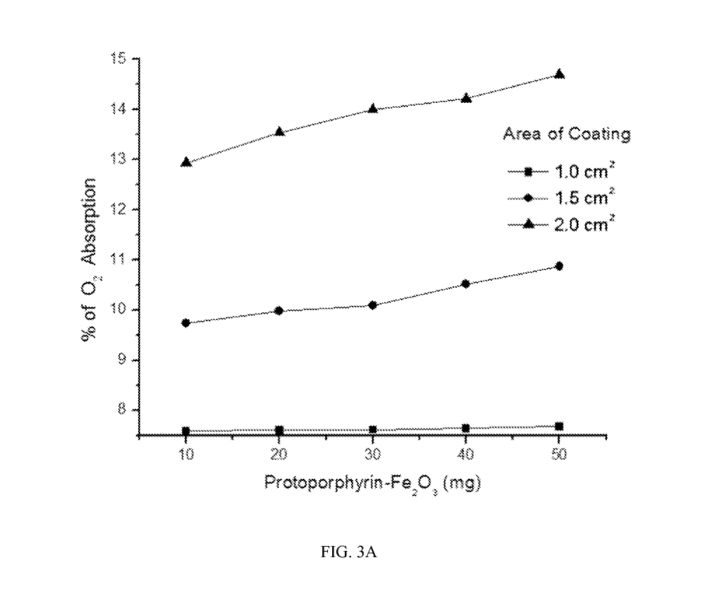

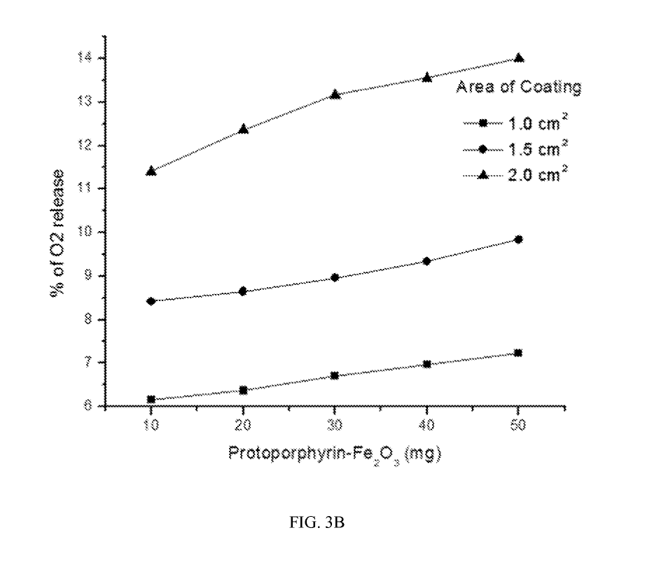

A graph showing the amount of oxygen adsorption vs. the amount of protoporphyrin IX-Fe₂O₃ particles, for each size of coated area, is provided in FIG. 3A. As can be seen from FIG. 3A, oxygen adsorption increases as the amount of protoporphyrin IX-Fe₂O₃ particles coated on the glass plate increases. Oxygen adsorption also increases as the size of the particle coated area of the glass plate increases.

A graph showing the amount of oxygen released vs. the amount of protoporphyrin IX-Fe₂O₃ particles, for each size of coated area, is provided in FIG. 3B. As can be seen from FIG. 3B, oxygen release increases as the amount of protoporphyrin IX-Fe₂O₃ particles coated on the glass plate increases. Oxygen release also increases as the size of the particle coated area of the glass plate increases.

### Example 6

### Oxygen Scavenging Increases Shelf-Life of Food

In an experimental setup, an apple was cut into two parts and one part was placed inside a beaker containing protoporphyrin IX-Fe₂O₃ particles and the beaker was covered by a paraffin film sheet with a rubber band. Another part of the apple was placed outside, adjacent to the beaker. The quality of the apple was monitored over a period of time (3 days). The apple piece kept outside the beaker displayed gradual browning on day 1, with increased decaying on day 2 and day 3. However, the apple piece kept inside the beaker looked relatively fresh and displayed slight browning on day 3, thus demonstrating the effectiveness of the protoporphyrin IX-Fe₂O₃ particles in scavenging oxygen and keeping the food fresh.

### Example 7

### Oxygen Scavenging Increases Shelf-Life of Fruits

In an experimental setup, an apple was cut into two parts and one part was placed inside a beaker containing protoporphyrin IX-Fe₂O₃ particles and the other part was placed in an identical beaker with no protoporphyrin IX-Fe₂O₃ particles. Both the beakers were covered by a paraffin film sheet with a rubber band and the quality of the apple was monitored. At the end of the two day period, the apple piece in the beaker without protoporphyrin IX-Fe₂O₃ particles displayed gradual browning. However, the apple piece in the beaker with protoporphyrin IX-Fe₂O₃ particles looked relatively fresh, thus demonstrating the effectiveness of the protoporphyrin IX-Fe2O3 particles in scavenging oxygen and keeping the fruit fresh.

### Example 8

### Re-Generation of Oxygen Scavenging Material

A polypropylene film having 30 milligrams of protoporphyrin IX-Fe₂O₃ particles on its surface is wrapped on the mouth of a vessel containing bread and other food stuff. The container is kept at room temperature and the contents are examined after two days. The contents in the container will remain fresh due to adsorption of oxygen by the protoporphyrin IX-Fe₂O₃ particles, demonstrating improved shelf-life. Further, the surface of the film will turn from brown to black due to oxygen adsorption. The film is removed and the surface is exposed to red light (630 nanometers, 500 lumens) for about 10 minutes. This will result in change of the color from black to brown due to reversal of Fe₃O₄ oxidation. The film is ready to use again for adsorbing oxygen.

### Example 9

### Use of the Adsorbent Material as Oxygen Scrubber for Gas

About 10 grams of protoporphyrin IX-Fe₂O₃ particles is packed in a stainless steel column of 400 millimeters in height and 7 millimeters in diameter. A feed mixture containing 70% oxygen by volume, 30% CO₂ by volume and trace amounts of nitrogen and hydrogen is allowed to pass through the adsorbent bed at a pressure of 1000 mm Hg. The output gas is re-fed and passed through the adsorbent bed again, repeating the cycle three times. The concentration of oxygen in the output gas is measured at the end of the cycle and will be found to be lower than 0.1% by volume. This demonstrates the use of adsorbent material as an oxygen scrubber. Such a scrubber may be advantageously employed in a number of gas scrubbing applications, for example, in natural gas pipelines, electrochemical processes and chemical processes that require oxygen-free atmosphere, and for anaerobic processes.

### Example 10

### Inert Gas Purifier

The disclosed composite material can be used to remove trace amount of oxygen present as a contaminant in many inert gases such as argon, helium and nitrogen. An experimental setup is described herein. About 100 grams of protoporphyrin IX-Fe₂O₃ particles are placed in a vacuum sealed steel canister and nitrogen gas containing trace amount of oxygen (10 ppm) is passed through the canister at 1000 mm Hg. The outlet gas is collected and measured for oxygen levels and will be found to be less than 10⁻⁶ ppm.

### Example 11

### Use of the Composite Material in an Oxygen Enrichment Process

When a fuel is burned, oxygen in the combustion air chemically combines with the hydrogen and carbon in the fuel to form water and carbon dioxide, releasing heat in the process. Air is made up of 21% oxygen, 78% nitrogen, and 1% other gases. During air-fuel combustion, the chemically inert nitrogen in the air dilutes the reactive oxygen and carries away some of the energy in the hot combustion exhaust gas. An increase in oxygen in the combustion air can reduce the energy loss in the exhaust gases and increase heating system efficiency.

The composite material of the present disclosure can be used to enrich oxygen in various industrial applications such as industrial furnaces, natural gas combustion etc. An oxygen enricher with protoporphyrin IX-Fe₂O₃ particles is described herein. About 400 grams of protoporphyrin IX-Fe₂O₃ particles are packed in a light permissible column of 2 feet long and 3 inches in diameter and air is passed through the column under pressure. The column is exposed to light of 630 nanometers for short durations during the process, which results in release of the adsorbed oxygen by protoporphyrin IX-Fe₂O₃ particles. The outlet air is measured for oxygen levels and will be found to contain at least three times more amount of oxygen when compared to the inlet air.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A reusable composite material to scavenge oxygen, the composite material comprising:
at least one porphyrin and at least one metal oxide comprised within the at least one porphyrin,
wherein the at least one metal oxide is oxidizable in the presence of oxygen, and
wherein oxidation of the at least one metal oxide is reversible upon exposure of the composite material to light of a fixed wavelength.

2. The reusable composite material of claim 1, wherein the at least one metal oxide comprises at least one transition metal oxide.

3. The reusable composite material of claim 1, wherein the at least one metal oxide is vanadium (II) oxide, iron (III) oxide, manganese (III) oxide, chromium (II) oxide, cobalt (II) oxide, nickel (II) oxide, copper (I) oxide, or combinations thereof.

4. The reusable composite material of claim 1, wherein the at least one metal oxide comprises iron (III) oxide (Fe₂O₃).

5. The reusable composite material of claim 1, wherein the porphyrin is protoporphyrin IX, porphine, octaethylporphine, hematoporphyrin IX, etioporphyrin, etioporphyrin I, meso-tetraphenylporphine, coproporphyrin I, coproporphyrin III, deuteroporphyrin IX, mesoporphyrin IX, tetratosylate, uroporphyrin I, iso-hematoporphyrin IX, or a combination thereof.

6. (canceled)

7. The reusable composite material of claim 1, wherein the composite material is in the form of microspheres, and wherein the microspheres have an average diameter of about 100 nanometers to about 500 nanometers.

8. (canceled)

9. The reusable composite material of claim 7, wherein the microspheres comprise protoporphyrin IX-Fe₂O₃ microspheres.

10. (canceled)

11. The reusable composite material of claim 1, wherein the fixed wavelength is about 380 nanometers to about 750 nanometers.

12. The reusable composite material of claim 1, wherein the reusable composite material changes color upon contact with oxygen.

13. A method for preparing a composite material for scavenging oxygen, the method comprising:
providing at least one metal oxide;
contacting the at least one metal oxide with a solution of thiol to form a metal oxide-thiol complex;
contacting the metal oxide-thiol complex with a solution of a cross-linking agent to form a first reaction mixture; and
contacting the first reaction mixture with a solution of at least one porphyrin to form a porphyrin-metal oxide composite material.

14.-17. (canceled)

18. The method of claim 13, wherein contacting the at least one metal oxide with the solution of thiol comprises contacting the at least one metal oxide with the solution of thiol for about 30 minutes.

19.-21. (canceled)

22. The method of claim 13, wherein contacting the metal oxide-thiol complex with the solution of cross-linking agent comprises contacting the metal oxide-thiol complex with the solution of cross-linking agent for about 10 minutes.

23.-29. (canceled)

30. The method of claim 13, wherein contacting the first solution mixture with the solution of porphyrin comprises contacting the first solution mixture with the solution of porphyrin for about 2 hours.

31. The method of claim 13, further comprising:
capturing the porphyrin-metal oxide composite material using a magnetic field; and
removing the unreacted components with water.

32. An article to scavenge oxygen, the article comprising:
at least one supporting material;
at least one reusable composite material comprising at least one porphyrin and at least one metal oxide comprised within the porphyrin,
wherein the at least one metal oxide is oxidizable in the presence of oxygen;
wherein oxidation of the at least one metal oxide is reversible upon exposure of the composite material to light of a fixed wavelength, and
wherein the reusable composite material is in contact with at least one surface of the supporting material.

33. The article of claim 32, wherein the at least one supporting material comprises polyethylene terephthalate, high-density polyethylene, low-density polyethylene, polypropylene, polystyrene, collagen, or a combination thereof.

34. (canceled)

35. The article of claim 32, wherein the at least one reusable composite material comprises protoporphyrin IX-Fe₂O₃ complex.

36. The article of claim 32, wherein the article is a container, a film or a sachet.

37. The article of claim 32, wherein the at least one supporting material is a sachet formed from a fibrous material, a synthetic material, a ceramic material, or a combination thereof.

38.-57. (canceled)

58. The reusable composite material of claim 1, wherein the at least one metal oxide comprises iron (III) oxide (Fe₂O₃), the porphyrin is protoporphyrin IX, and the composite material is in the form of microspheres.

59. The reusable composite material of claim 1, wherein the fixed wavelength is about 380 nanometers to about 750 nanometers and the reusable composite material changes color upon contact with oxygen.
